(19) United States
(12) Patent Application Publication
(10) Pub. No.: US 2012/0294619 A1
(43) Pub. Date: Nov. 22, 2012

(54) NOVEL ARCHITECTURE FOR UNDERSEA REPEATERLESS SYSTEMS

(75) Inventors: Lee John Richardson, Freehold, NJ (US); Ekaterina A. Golovchenko, Colts Neck, NJ (US)

(73) Assignee: Tyco Electronics Subsea Communications LLC, Morristown, NJ (US)

(21) Appl. No.: 13/111,547

(22) Filed: May 19, 2011

(51) Int. Cl. H04B 13/02; H04B 10/00

(52) U.S. Cl. 398/105; 398/157

(57) ABSTRACT

An undersea repeaterless optical transmission system is disclosed including first and second stations connected by a communication link which may comprise one or more optical fibers. The system further includes a dedicated Raman pumping path originating from a third intermediate station and interacting with the communication link at an undersea body positioned between the first and second stations. This dedicated Raman pumping path may comprise one or more optical fibers. Communications signals are propagated only between the first and second stations, while the third intermediate station provides only Raman pumping via the pumping path which is used to boost signal power in the communication link between the first and second stations. By limiting this pumping path to Raman pumping only substantially more pumping power can be provided through the path since power is not limited by the equation of a communications signal. The disclosed system architecture facilitates increased capacity (or reach) on the repeaterless link between the first and second stations.

### TECHNICAL FIELD

Embodiments of the present disclosure relate to the field of optical communication systems. More particularly, the present disclosure relates to the use of Raman pumping to increase capacity and reach of repeaterless optical communication systems.

### DISCUSSION OF RELATED ART

In optical communication systems, wavelength division multiplexing (WDM) or dense wavelength division multiplexing (DWDM) is used to transmit optical signals long distances where a plurality of optical channels, each at a particular wavelength, propagate over fiber optic cables. However, certain optical communication systems, in particular long-haul networks of lengths greater than about 500 kilometers, inevitably suffer from deleterious effects due to a variety of factors including scattering, absorption, and/or bending. To compensate for losses, optical amplifiers are typically placed at regular intervals, for example about every 50 kilometers, to repeat and boost the optical signal. However, such repeatered systems may be expensive to build and maintain in contrast to repeaterless systems that do not rely on multiple optical amplifiers to boost the optical signal.

Despite fairly complex transmit and receive terminals involving high-power boosters and Raman pumps, repeaterless systems may provide a lower overall system cost compared to repeatered systems as repeaterless systems avoid the need to power-feed, supervise and maintain costly in line erbium-doped fibre amplifiers (EDFAs). In certain repeaterless systems, Raman amplifiers are used to avoid such system complexity and costs. Generally, Raman amplification is accomplished by introducing the signal and pump energies along the same optical fiber. A Raman amplifier uses Stimulated Raman Scattering (SRS), which occurs in silica fibers when an intense pump beam propagates through it. SRS is an inelastic scattering process in which an incident pump photon loses its energy to create another photon of reduced energy at a lower frequency. The remaining energy is absorbed by the fiber medium in the form of molecular vibrations (i.e., optical phonons). That is, pump energy of a given wavelength amplifies a signal at a longer wavelength. The pump and signal may be co-propagating or counter propagating with respect to one another. Thus, optical WDM transmission up to a few hundred kilometers in a Digital Line Section (DLS) can be implemented using repeaterless systems making them an attractive candidate for island hopping, festoons as well as optical add-drop multiplexer (OADM) branches in transoceanic networks.

In long repeaterless systems, the WDM or DWDM channels need to be launched with higher powers from the transmitter to result in adequate optical signal-to-noise ratio (OSNR) and performance on the receive end. Various non-linear transmission effects may limit the maximum possible launch power and, as a result, the system reach and capacity. In certain geographic conditions, it may be desirable to provide increased capacity or reach while maintaining launch powers within a DLS of a repeaterless system. Thus, a need exists for an improved pumping arrangement to increase capacity and reach in an undersea repeaterless DLS.

### SUMMARY OF THE DISCLOSURE

Exemplary embodiments of the present disclosure are directed to a novel architecture for undersea repeaterless fiber optic communication systems to facilitate increased capacity or reach. In an exemplary embodiment, a communications system includes a first and second communications stations and a repeaterless communications link connecting the first and second stations. An intermediate station is coupled to the repeaterless communications link via a dedicated Raman pumping path where a Raman pump, associated with the intermediate station, is coupled to the dedicated Raman pumping path for increasing gain of a communications signals sent from the first and second communications stations.

In an exemplary method, a communication signal is propagated from a first station to a second station along a repeaterless communication link. Signal gain is provided to the communication signal via a Remote Optically Pumped Amplifier (ROPA) coupled to the communication link where the ROPA is excited by a Raman pump propagating from the receiver station. A Raman pumping signal is provided from an additional Raman pump coupled to the communication link via a dedicated Raman pumping path from an intermediate station located between the first and second stations. The Raman pumping signal is provided to the communication link at an undersea body. Signal gain is provided to the communication signal via a ROPA coupled to the communication link and excited by the additional Raman pump.

### BRIEF DESCRIPTION OF THE DRAWINGS

FIG. 1 is schematic of an embodiment of an undersea repeaterless optical transmission system incorporating a dedicated Raman pumping path originating from an intermediate station;

FIG. 2 is a block diagram of the system of FIG. 1;

FIG. 3 is a schematic of a further embodiment of an undersea repeaterless optical transmission system incorporating multiple dedicated Raman pumping paths originating from multiple intermediate stations;

FIG. 4 is a schematic of another embodiment of an undersea repeaterless optical transmission system incorporating a dedicated Raman pumping path originating from an intermediate station; and

FIG. 5 is a diagram of a method to implement intermediate dedicated Raman pumping of an undersea repeaterless optical transmission system in accordance with one or more embodiments.

It will be appreciated that for simplicity and/or clarity of illustration, elements illustrated in the figures have not necessarily been drawn to scale. For example, the dimensions of some of the elements may be exaggerated relative to other elements for clarity. Further, if considered appropriate, reference numerals have been repeated among the figures to indicate corresponding and/or analogous elements.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail. In addition, the present disclosure may be embodied in many different forms and should not be construed as limited to the embodiments set forth herein. Rather, these embodiments are provided so that this disclosure will be thorough and complete, and will fully convey the scope of the invention to those skilled in the art. In the drawings, like numbers refer to like elements throughout.

In the following description and/or claims, the terms coupled and/or connected, along with their derivatives, may be used. In particular embodiments, connected may be used to indicate that two or more elements are in direct physical and/or electrical contact with each other. Coupled may mean that two or more elements are in direct physical and/or electrical contact. However, coupled may also mean that two or more elements may not be in direct contact with each other, but yet may still cooperate and/or interact with each other. For example, “coupled” may mean that two or more elements do not contact each other but are indirectly joined together via another element or intermediate elements. Finally, the terms “on,” “overlying,” and “over” may be used in the following description and claims. “On,” “overlying,” and “over” may be used to indicate that two or more elements are in direct physical contact with each other. However, “over” may also mean that two or more elements are not in direct contact with each other. For example, “over” may mean that one element is above another element but not contact each other and may have another element or elements in between the two elements. Furthermore, the term “and/or” may mean “and”, it may mean “or”, it may mean “exclusive-or”, it may mean “one”, it may mean “some, but not all”, it may mean “neither”, and/or it may mean “both”, although the scope of claimed subject matter is not limited in this respect. In the following description and/or claims, the terms “comprise” and “include,” along with their derivatives, may be used and are intended as synonyms for each other.

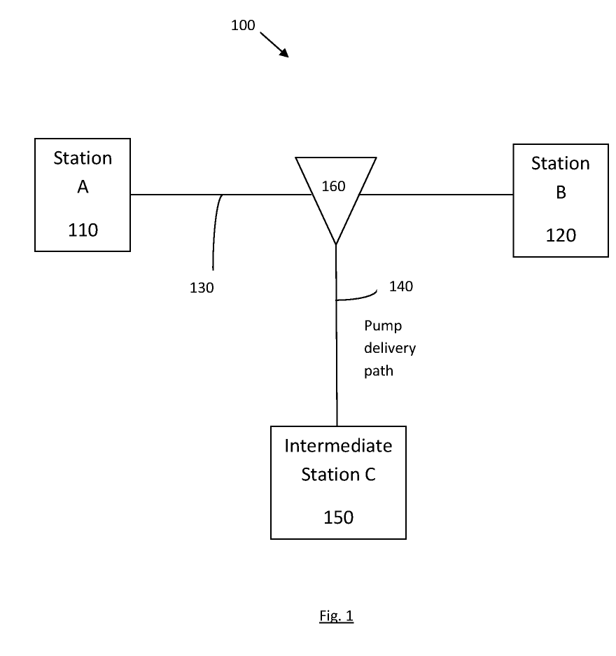

Presently disclosed embodiments provide an architecture for undersea repeaterless systems that utilizes dedicated pumping paths originating from an intermediate station to boost signal power in a DLS. Referring now to FIG. 1, a block diagram of an exemplary repeaterless optical transmission system is shown. It should be noted that although FIG. 1 shows one example of a repeaterless optical transmission system 100 for purposes of discussion, various other versions and/or embodiments of system 100 may be utilized, with more or fewer elements than shown, and the scope of the claimed subject matter is not limited in this respect. An undersea repeaterless optical transmission system 100 is illustrated, and includes station A 110 and station B 120 connected by a communication link 130, which in one embodiment comprises an undersea optical cable housing one or more optical fibers. A DLS is defined between stations 110, 120 and fiber cable 130. Stations 110 and 120 include transmitters and receivers to transmit and receive DWDM optical communication signals therebetween. It is important to note that loss associated with the optical channels that comprise the DWDM signal is not constant across the transmitted wavelengths. Thus, signal quality at the respective receiver portions of stations 110 and 120 of the DLS may be different for each wavelength. Thus, system 100 is designed to compensate for such variations to obtain adequate system margin across all the wavelengths for transmission between stations 110 and 120.

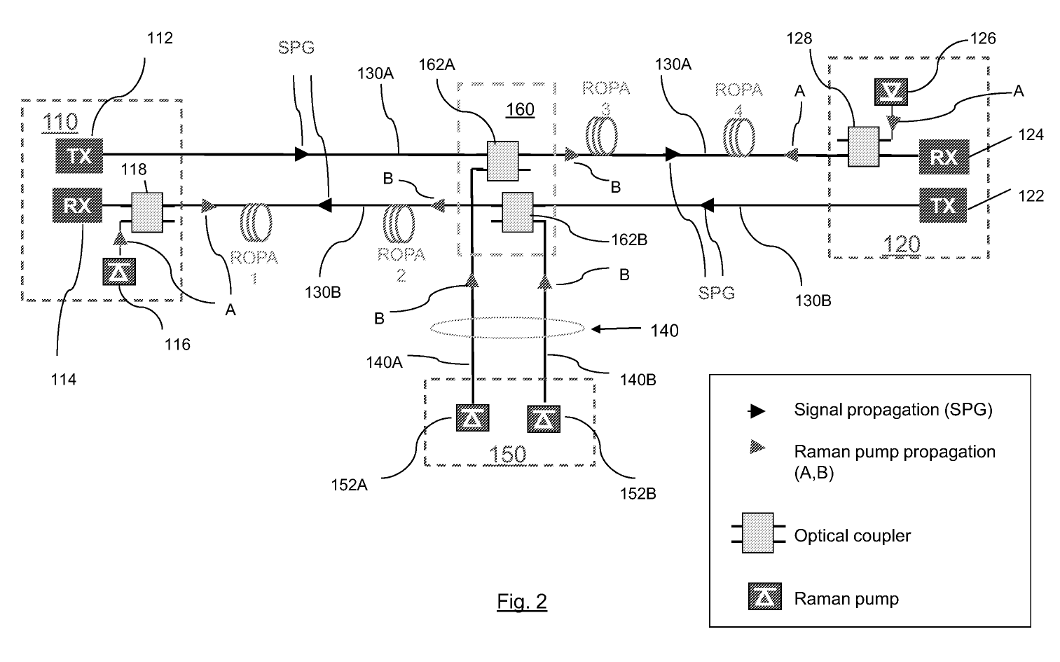

The system 100 further includes a dedicated pumping path 140 originating from an intermediate station C, 150. The pumping path 140 may include a plurality of dedicated pump delivery fibers which supplies optical pump signals to communication link 130 via undersea body 160 positioned between the first and second stations 110, 120. Undersea body 160 includes one or more optical couplers configured to route the optical pump signals from intermediate station 150 via delivery path 140 to the DLS formed between stations 110 and 120. As will be described in greater detail, the illustrated system architecture facilitates increased capacity (or reach) on the repeaterless link between the first and second stations 110, 120. Communications signals are propagated only between the first and second stations identified by arrows “SPG” (shown in FIG. 2) and not between the intermediate station 150 and either of the first 110 or second stations 120. Thus, the third intermediate station 150 provides only dedicated Raman pumping via the pumping path 140 to boost signal gain in the communication link 130. By limiting the pumping path 140 to Raman pumping only (i.e., no communications signals) it is possible to provide substantially more power through the path, since pumping power is not limited by interference between payload channels transmitted over the DLS.

FIG. 2 shows an exemplary arrangement of components of the system 100 of FIG. 1 with the Raman pumps from intermediate station C, 150 co-propagating with the optical signals between stations 110 and 120. The first and second stations 110, 120 include a transmitter module 112, 122, a receiver module 114, 124 and a Raman pump 116, 126. The Raman pumps 116, 126 are coupled to respective communication lines 130A, 130B of the communication link 130 via optical couplers 118, 128. Each of the communications lines 130A, 130B includes a ROPA (Remote Optically Pumped Amplifier) (identified as ROPA 1, ROPA 4) which are excited by the Raman pumps 116, 126 located at the first and second stations 110, 120 resulting in Raman pumping paths (identified by arrows A).

As noted above, the intermediate station 150 has no telemetry equipment, and so no DLS communication exists between the first station 110 and the intermediate station 150, or between the second station 120 and the intermediate station 150. The intermediate station 150 or station C includes first and second Raman pumps 152A, 152B which are connected, via first and second communications lines 140A, 140B of the Raman pumping path 140, to respective communication lines 130A, 130B of the communication link 130. The first and second communications lines 140A, 140B are coupled to the first and second communication lines 130A, 130B via respective optical couplers 162A, 162B associated with the undersea body 160. The first and second Raman pumps 152A, 152B are coupled into the communication link 130 in a co-propagating direction (identified by arrows “B”).

The Raman pumps 152A, 152B launched from the intermediate station 150 propagate through the optical fibers of the communications lines 140A, 140B until they reach respective optical couplers 162A, 162B of the undersea body 160. Since the Raman pumps 152A, 152B are coupled to the communication link 130 in a co-propagating direction, the Raman pumps 152A, 152B cause signal gain in the transmission fibers of the communication link 130.

In one embodiment, the Raman pumps 152A, 152B excite additional ROPAs associated with the communication link 130. Thus, additional ROPAs (identified as ROPA 2, ROPA 3) are located close to the undersea body 160 in each of the communications lines 130A, 130B of the communication link 130. The proximity of the additional ROPAs (identified as ROPA 2, ROPA 3) to the undersea body 160 is governed by the length of link 140 and its concomitant loss. The smaller the optical loss at the link 140, then the further away from the undersea body 160 ROPA 2, ROPA 3 can be located. Generally, the proximity of the ROPAs to undersea body 160 depends on several factors such as, but not limited to, Erbium efficiency, length, coupler losses, pump attenuation in link 140, etc.

It will be appreciated that the disclosed architecture of FIGS. 1 and 2 can, in some embodiments, be expanded to conventional Optical Add-Drop Multiplexer (OADM) and Branching Unit (BU) configurations that deliver communications traffic to the intermediate station 150. Such an expanded configuration would still employ at least one dedicated Raman pumping path to provide a desired signal gain in the fibers of the communication link 130 between the first and second stations 110, 120. Communications links between the intermediate station 150 and the first or second station 110, 120 would be accomplished by a separate optical fiber transmission line or lines.

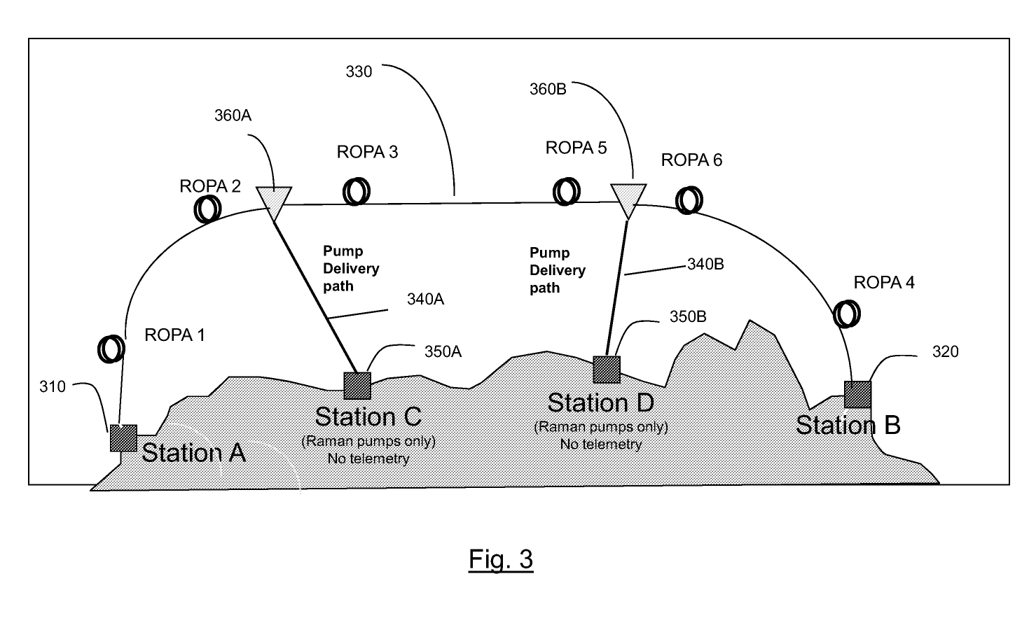

FIG. 3 shows a further embodiment of an undersea repeaterless optical transmission system incorporating multiple dedicated Raman pumping paths originating from multiple intermediate stations. Specifically, the FIG. 3 embodiment illustrates a pair of intermediate stations 350A, 350B coupled to the communication link 330 between the first and second stations 310, 320 via respective undersea bodies 360A, 360B. As with the embodiment of FIGS. 1 and 2, communications traffic only propagates on DLS between the first and second stations, while the intermediate stations 350A, 350B provide only Raman pumping through associated dedicated delivery paths 340A, 340B.

Each of the intermediate stations 350A, 350B includes additional Raman pumps coupled to the communication link 330 in a co-propagating direction. ROPAs 1 and 4 are excited by the Raman pumps located at the first and second stations 310, 320 in the manner described in relation to FIG. 2. ROPAs 2 and 3 are excited by the Raman pumps associated with intermediate station 350A, while ROPAs 5 and 6 are excited by the Raman pumps associated with intermediate station 350B. ROPAs 2, 3, 5 and 6 are coupled to the communication link 330 in a co-propagating direction to cause a desired signal gain in the transmission fibers of the communication link 330. Although two intermediate Raman pumping stations are illustrated in FIG. 3, it will be appreciated that the Raman pumping arrangement can be extended to include multiple additional intermediate stations to facilitate communications between the first and second stations 310, 320 over increased distances. The number of required intermediate stations is dependant, in addition to physical length, on the signal capacity required between station A 310 and station B 320. In other words, the higher the signal capacity, the more intermediate stations will be required.

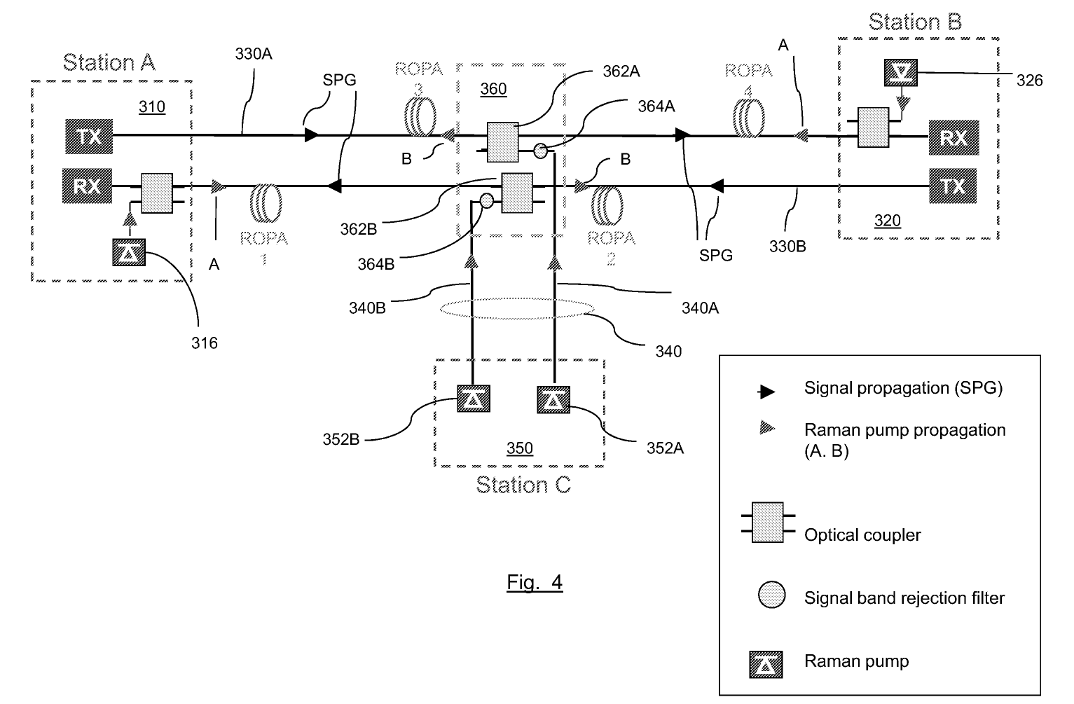

FIG. 4 is a schematic of a further embodiment of an undersea repeaterless optical transmission system incorporating a dedicated Raman pumping path originating from an intermediate station. The first and second stations 310, 320 are configured in substantially the same manner as described in relation to the embodiment illustrated in FIG. 2. The intermediate station 350 includes dedicated delivery paths 340A, 340B coupled to the communications lines 330A, 330B of the communications link 330 between the first and second stations 310, 320. Individual Raman pumps 352A, 352B are coupled to the dedicated delivery paths 340A, 340B to provide Raman pumping to the communications lines 330A, 330B in a co-propagating direction (identified by arrows “B”).

The FIG. 4 embodiment further includes a signal band rejection filter 364A, 364B disposed in each of the dedicated delivery paths 340A, 340B between the Raman pumps 352A, 352B and the optical couplers 362A, 362B used to couple the paths 340A, 340B to the communications lines 330A, 330B. These signal band rejection filters 364A, 364B prevent the signals 330A, 330B propagating down the pump delivery paths 340A, 340B from further depleting the Raman pumps 352A, 352B. An equivalent device such as an optical isolator may be employed in place of band rejection filters 364A, 364B. ROPA's 1 and 4 are provided in the communications lines 330B, 330A and are excited by the Raman pumps 316, 326 located at the first and second stations 310, 320 resulting in Raman pumping paths (identified by arrows “A”). Signal propagation between the first and second stations 310, 320 is identified by arrows “SPG.” ROPA's 2 and 3 are provided in communication lines 330B, 330A, and are excited by the Raman pumps 352B, 352A located at the intermediate station 350. In contrast to the configuration shown in FIG. 2, the corresponding ROPA (e.g. ROPA 3) for a given communication line (e.g. 330A) is on the opposite side of the branching unit or undersea body 360. Whereas, in the configuration shown in FIG. 2, the ROPA's 2 and 4 are on the same side of the undersea body 160. For any particular system, the optimal configuration (i.e. FIG. 2 or FIG. 4) will depend on the optical losses between stations 310, 320 and undersea body 360.

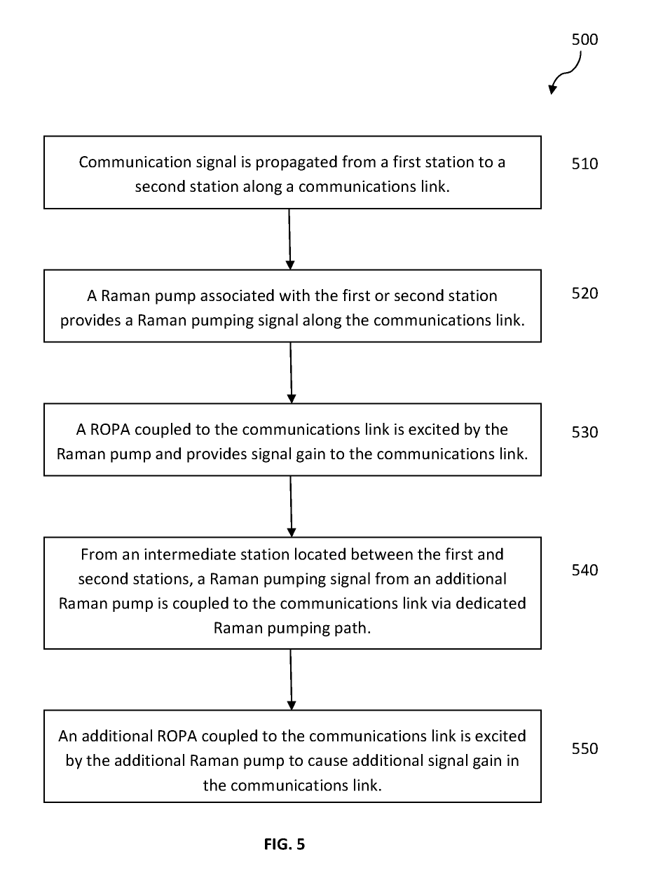

FIG. 5 is a flow chart of a method to implement intermediate dedicated Raman pumping of an undersea repeaterless optical transmission system in accordance with one or more embodiments. It should be noted that although FIG. 5 shows one particular order of the elements of method 500 as just one example, alternative orders of method 500 may likewise be implemented, and method 500 may include more or fewer elements than shown in FIG. 5, and further may be executed with the structure shown in and described herein or variations thereof, and the scope of the claimed subject matter is not limited in these respects. As shown in FIG. 5, in a repeaterless system a communications signal may be propagated at block 510 from a first station 310 to a second station 320 along a communications link 330. At block 520, a Raman pump 316, 326 associated with the first or second station 310, 320, may provide a Raman pumping signal along the communications link 330. At block 530, a ROPA (ROPA 1, ROPA 4) coupled to the communications link may be excited by the Raman pump 316, 326 to provide signal gain to the communications link 330. From an intermediate station 350 located between the first and second stations, a Raman pumping signal from an additional Raman pump 352A, 352B may be coupled at block 540 to the communications link 330 via a dedicated Raman pumping path 340A, 340B. At block 550, an additional ROPA (ROPA 2, ROPA 3) coupled to the communication link 330 in a co-propagating direction may be excited by the additional Raman pump 352A, 352B to cause additional signal gain in the communication link 330.

Although the claimed subject matter has been described with a certain degree of particularity, it should be recognized that elements thereof may be altered by persons skilled in the art without departing from the spirit and/or scope of claimed subject matter. It is believed that the subject matter will be understood by the forgoing description, and it will be apparent that various changes may be made in the form, construction and/or arrangement of the components thereof without departing from the scope and/or spirit of the claimed subject matter or without sacrificing all of its material advantages, the form herein before described being merely an explanatory embodiment thereof, and/or further without providing substantial change thereto. It is the intention of the claims to encompass and/or include such changes.

The method described herein may be automated by, for example, tangibly embodying a program of instructions upon a computer readable storage media capable of being read by machine capable of executing the instructions. A general purpose computer is one example of such a machine. A non-limiting exemplary list of appropriate storage media well known in the art would include such devices as a readable or writeable CD, flash memory chips (e.g., thumb drives), various magnetic storage media, and the like.

The features of the method have been disclosed, and further variations will be apparent to persons skilled in the art. All such variations are considered to be within the scope of the appended claims. Reference should be made to the appended claims, rather than the foregoing specification, as indicating the true scope of the disclosed method. The functions and process steps herein may be performed automatically or wholly or partially in response to user command. An activity (including a step) performed automatically is performed in response to executable instruction or device operation without user direct initiation of the activity.

The systems and methods disclosed herein are not exclusive. Other systems and methods may be derived in accordance with the principles of the disclosure to accomplish the same objectives. Although the systems and methods have been described with reference to particular embodiments, it is to be understood that the embodiments and variations shown and described herein are for illustration purposes only. Modifications to the current design may be implemented by those skilled in the art, without departing from the scope of the invention. The processes and applications may, in alternative embodiments, be located on one or more (e.g., distributed) processing devices accessing a network linking the elements of the disclosed systems. Further, any of the functions and steps provided in FIG. 5 may be implemented in hardware, software or a combination of both and may reside on one or more processing devices located at any location of a network linking the elements of the disclosed systems or another linked network, including the Internet.

What is claimed is:

1. A communications system, comprising:
first and second communications stations;
a repeaterless communications link connecting said first and second stations;
an intermediate station coupled to said repeaterless communications link via a dedicated Raman pumping path; and
a Raman pump associated with said intermediate station, said Raman pump coupled to said dedicated Raman pumping path for increasing gain of a communications signal sent from one of the first and second communications stations.

2. The system of claim 1, wherein the repeaterless communications link comprises first and second communication lines, the first and second communications lines including one or more optical fibers defining a digital line section.

3. The system of claim 2, wherein the dedicated Raman pumping path comprises first and second pumping lines, the first and second pumping lines coupled to the first and second communication lines, respectively.

4. The system of claim 3, wherein the intermediate station includes first and second Raman pumps connected to the first and second pumping lines.

5. The system of claim 4, wherein the first and second Raman pumps are coupled into the first and second communication lines in a co-propagating direction.

6. The system of claim 3, wherein each of the first and second stations further comprises a Raman pump, and wherein Remote Optically Pumped Amplifiers (ROPAs) are further coupled to the first and second communication lines adjacent the first and second stations such that each of said ROPAs is excited by an associated Raman pump from the intermediate station.

7. The system of claim 3, wherein the first and second communications lines are coupled to the first and second pumping lines at an undersea body, the system further comprising:
a ROPA coupled to the first communication line adjacent to the undersea body and excited by the first Raman pump of the Intermediate station, and
a ROPA coupled to the second communication line adjacent to the undersea body and excited by the second Raman pump of the intermediate station.

8. The system of claim 3 further comprising first and second signal band rejection filters coupled to the first and second dedicated pumping lines at an undersea body.

9. The system of claim 2, further comprising an additional intermediate station coupled to said first and second communication lines via first and second dedicated Raman pumping paths.

10. A long haul repeaterless communications system, comprising:
first and second communications stations coupled by a repeaterless link having first and second communication lines;
an intermediate station coupled to said first and second communication lines via first and second dedicated Raman pumping paths; and
first and second Raman pumps associated with said intermediate station, said first Raman pump coupled to said first dedicated Raman pumping path and said second Raman pump coupled to said second dedicated Raman pumping path;
wherein said first and second Raman pumps increase gain of communications signals sent between said first and second communications stations.

11. The system of claim 10, wherein the first and second communications lines include one or more optical fibers.

12. The system of claim 10, wherein the first and second Raman pumps are coupled into the first and second communication lines in a co-propagating direction.

13. The system of claim 10, wherein the first and second stations further each comprise a Raman pump, and wherein Remote Optically Pumped Amplifiers (ROPAs) are further coupled to the first and second communication lines adjacent the first and second stations such that each of said ROPAs is excited by an associated Raman pump.

14. The system of claim 10, further comprising:
a first ROPA coupled to the first communication line adjacent to the undersea body and excited by the first Raman pump of the Intermediate station, and
a second ROPA coupled to the second communication line adjacent to the undersea body and excited by the second Raman pump of the Intermediate station.

15. The system of claim 10, further comprising first and second signal band rejection filters coupled to the first and second dedicated pumping lines at the undersea body.

16. A method for long haul repeaterless communication, comprising:
propagating a communication signal from a first station to a second station along a repeaterless communication link;
providing a Raman pumping signal to the communication link at an undersea body;
providing signal gain to the communication signal via a Remote Optically Pumped Amplifier (ROPA) coupled to the communication link, wherein said ROPA is excited by a Raman pump associated with the first or second station;
from an intermediate station located between the first and second stations, providing a Raman pumping signal from an additional Raman pump coupled to the communication link via a dedicated Raman pumping path; and
providing signal gain to the communication signal via a ROPA coupled to the communication link and excited by the additional Raman pump.

17. The method of claim 16, wherein the step of providing a Raman pumping signal to the communication link at an undersea body comprises providing an intermediate station having first and second Raman pumps coupled to first and second dedicated pumping paths, the first and second dedicated pumping paths being coupled to first and second communication lines of the communication link.

18. The method of claim 17, further comprising providing a Raman pumping signal to the communication link at an additional undersea body via an additional intermediate station having first and second Raman pumps coupled to first and second dedicated pumping paths, the first and second dedicated pumping paths being coupled to first and second communication lines of the communication link.

19. The method of claim 17, further comprising filtering the Raman pumping signal from said first and second Raman pumps located at said intermediate station.

20. The method of claim 19, wherein said step of filtering is performed using first and second signal band rejection filters disposed in said first and second dedicated pumping paths.

21. The method of claim 20, wherein said first and second signal band rejection filters are associated with said undersea body.
